(19) United States
(12) Patent Application Publication
(10) Pub. No.: US 2017/0151826 A1
(43) Pub. Date: Jun. 1, 2017

(54) FEEDING PENCIL

(71) Applicant: TOKIWA CORPORATION, Gifu (JP)

(72) Inventor: Yoshikazu TANI, Saitama (JP)

(73) Assignee: TOKIWA CORPORATION, Gifu (JP)

(21) Appl. No.: 15/354,258

(22) Filed: Nov. 17, 2016

(30) Foreign Application Priority Data
Nov. 30, 2015 (JP) 2015-233491

(51) Int. Cl. B43K 24/12; B43K 21/08

(52) U.S. Cl. CPC B43K 24/12; B43K 21/08

(57) ABSTRACT

A feeding pencil includes a main body, a leading tube, a middle tube, and a ratchet mechanism. The middle tube is engaged to the leading tube to be relatively rotatable. A relative rotation between the leading tube and the main body in one direction moves a drawing material forward. The ratchet mechanism allows the relative rotation between the leading tube and the main body in the one direction, and regulates the relative rotation in another direction. The ratchet mechanism includes an elastic projecting part and a concave-convex part. The concave-convex part engages with the elastic projecting part to be movable in an axial direction and rotatable. A protrusion disposed at a center tube removably engages with an annular convex part disposed at an outer surface of the leading tube in the axial direction.

### TECHNICAL FIELD

The present disclosure relates to a feeding pencil used by extruding a drawing material.

### BACKGROUND ART

Conventionally, there has been known a feeding pencil disclosed in, for example, Japanese Unexamined Patent Application Publication No. 2015-024081. This patent publication discloses an applying material extruding container that appropriately extrudes a filled applying material by user's operation. This applying material extruding container includes a filling member, a control cylinder, a movable body, and a screw cylinder. The filling member internally includes a filling region filled with the applying material. The control cylinder is coupled to a rear end part of the filling member so as to be relatively rotatable with respect to the filling member. The relative rotation of the filling member and the control cylinder moves the movable body in an axial direction. The screw cylinder ensures the movement of the movable body by this relative rotation.

With the above-described applying material extruding container, the screw cylinder includes a rear end tube. The control cylinder includes an internal tubular part internally inserted into the rear end tube. On an outer circumferential surface of the internal tubular part, a protrusion on one side that protrudes outwardly in a radial direction is provided. On an inner circumferential surface of the rear end tube, a protrusion on the other side that protrudes inwardly in the radial direction and that engages with the protrusion on one side in a rotation direction is provided. The protrusion on the other side has elasticity in the radial direction by cutouts therearound. In a state where the internal tubular part has not yet been inserted to the inside of the rear end tube, an inner diameter of a tip end of the other protrusion is smaller than an outer diameter of the outer circumferential surface of the rear end tube. In a state where the internal tubular part is inserted to the inside, the other protrusion is always brought into abutment with the outer circumferential surface of the rear end tube.

### CITATION LIST

### Patent Literature

Patent Literature 1: Japanese Unexamined Patent Application Publication No. 2015-024081

### SUMMARY OF INVENTION

### Technical Problem

Recently, various kinds of requests have been increased for a feeding pencil like the above-described applying material extruding container. The feeding pencil that can be easily decomposed and whose internal components can be easily exchanged by a user has been desired. That is, in case of a failure in the internal component or a similar failure, the feeding pencil decomposed to ensure the easy exchange of this component by the user has been desired.

An object of the present disclosure is to provide a feeding pencil that can be easily decomposed and whose internal components can be easily exchanged.

### Solution to Problem

To solve the above-described problems, a feeding pencil according to the present disclosure includes a tubular main body, a leading tube, a middle tube and a ratchet mechanism. The leading is tube configured to be rotatably engaged with the main body. The middle tube has a tube portion configured to be inserted into a rear side portion of the leading tube. The middle tube is positioned between the leading tube and the main body and is configured to be rotatably engaged with the leading tube. The relative rotation between the leading tube and the main body in one direction moves a drawing material forward inside of the leading tube. The ratchet mechanism is configured to allow the relative rotation between the leading tube and the main body in one direction. The ratchet mechanism is configured to regulate the relative rotation in other direction opposite from the one direction. The ratchet mechanism includes an elastic projecting part and a concave-convex part, the elastic projecting part projecting from an outer surface on the tube portion, the elastic projecting part having elasticity in a radial direction, the concave-convex part being disposed on an inner surface of the leading tube, the concave-convex part being configured to engage with the elastic projecting part to be movable in an axial direction and rotatable. A projection disposed at any one of the outer surface of the tube portion and the inner surface of the leading tube is configured to removably engage with an annular convex part disposed at another in the axial direction.

This feeding pencil includes the ratchet mechanism that allows the relative rotation between the leading tube and the main body in the one direction and regulates the relative rotation in the other direction. The ratchet mechanism includes the elastic projecting part, which projects from the outer surface on the tube portion of the middle tube, and the concave-convex part on the inner surface of the leading tube. In this ratchet mechanism, the concave-convex part on the inner surface of the leading tube is movable with respect to the elastic projecting part on the outer surface of the tube portion in the axial direction. The protrusion disposed at any one of the outer surface of the tube portion and the inner surface on the leading tube removably engages with the annular convex part, which is disposed at the other, in the axial direction. Therefore, the leading tube can be removably attachable to the middle tube in the axial direction, thereby ensuring easy decomposition by removing the leading tube from the middle tube. Accordingly, in case of a failure in the internal component or a similar case, the user can remove the leading tube and easily exchange the internal component.

The feeding pencil may be configured as follows. The plurality of drawing materials are stored in the leading tube. The plurality of sliding parts coupled to the plurality of drawing materials respectively are disposed. The plurality of sliding parts are slidable with respect to the main body by a predetermined amount. One arbitrary sliding part, out of the plurality of sliding parts, moves forward by a predetermined amount with respect to the main body, whereby the drawing material coupled with the one arbitrary sliding part is exposed from the leading tube, and in this state, the leading tube and the main body are relatively rotated in one direction, which allows the drawing material to move forward. In this case, the plurality of drawing materials can be stored in a feeding pencil, and the one any given drawing material can be moved forward for use.

### Advantageous Effects of Invention

According to the present disclosure, the feeding pencil can be easily decomposed, and the internal component of the feeding pencil can be easily exchanged.

### BRIEF DESCRIPTION OF DRAWINGS

FIG. 1 is a side view illustrating a feeding pencil according to an embodiment;

FIG. 2 is a side view illustrating the feeding pencil in FIG. 1 from which a leading tube and one cartridge are removed;

FIG. 3 is a vertical cross-sectional view illustrating the feeding pencil in FIG. 1;

FIG. 4 is a vertical cross-sectional view illustrating a drawing material, a pipe member, a holding member, and a sliding part;

FIG. 5 is a cross-sectional perspective view illustrating the feeding pencil in FIG. 1;

FIG. 6 is a vertical cross-sectional view illustrating the one sliding part in the feeding pencil in FIG. 1 moved forward;

FIG. 7 is a cross-sectional perspective view illustrating the feeding pencil in a state of FIG. 6;

FIG. 8 is a vertical cross-sectional view illustrating a leading tube;

FIG. 9A is a side view illustrating an middle tube, and FIG. 9B is a vertical cross-sectional view illustrating the middle tube;

FIG. 10 is a cross-sectional view taken along the line A-A in FIG. 1;

FIG. 11A is a vertical cross-sectional view illustrating a holding member, and FIG. 11B is an enlarged view of a front end part of the holding member in FIG. 11A;

FIG. 12A is a perspective view illustrating a movable body, and FIG. 12B is a side view illustrating the movable body;

FIG. 13A is a side view illustrating the pipe member, and FIG. 13B is a vertical cross-sectional view illustrating the pipe member;

FIG. 14A is a side view illustrating a the sliding part, and FIG. 14B is a perspective view illustrating the sliding part;

FIG. 15A is a vertical cross-sectional view illustrating a main body, FIG. 15B is a side view illustrating the main body, and FIG. 15C is a cross-sectional view taken along the line C-C in FIG. 15B; and

FIG. 16A is a vertical cross-sectional view illustrating the pipe member, the movable body, and the holding member, and FIG. 16B is a diagram enlarging a vicinity of a rear end of the pipe member in FIG. 16A.

### DESCRIPTION OF EMBODIMENTS

The following describes embodiments of the present disclosure with reference to the drawings. In the following description, the identical or corresponding elements are identified with the identical symbols, and their description will not be repeated.

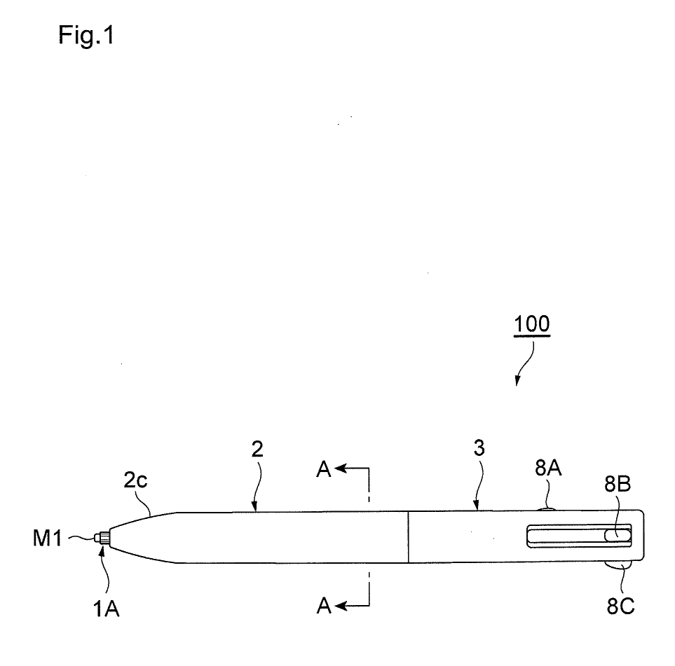

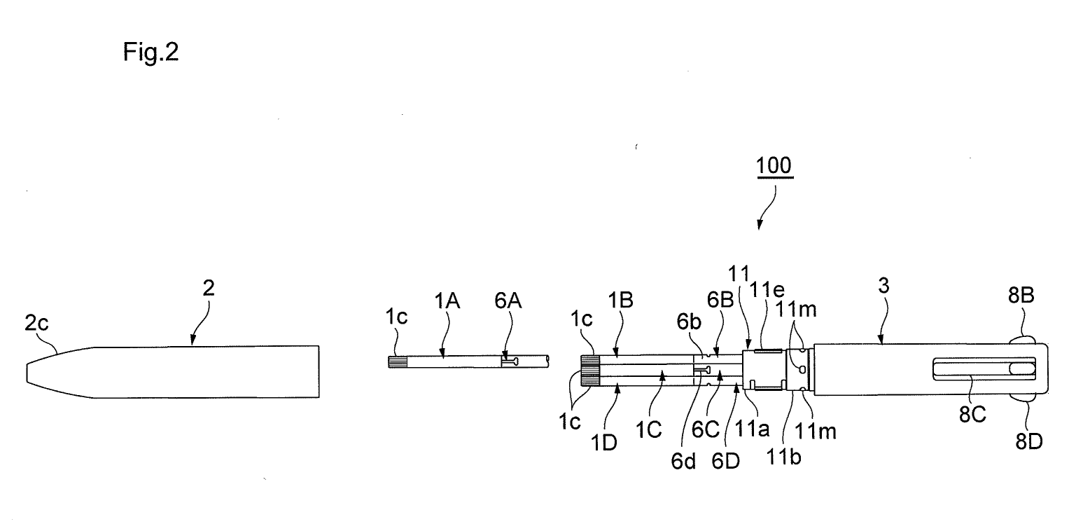

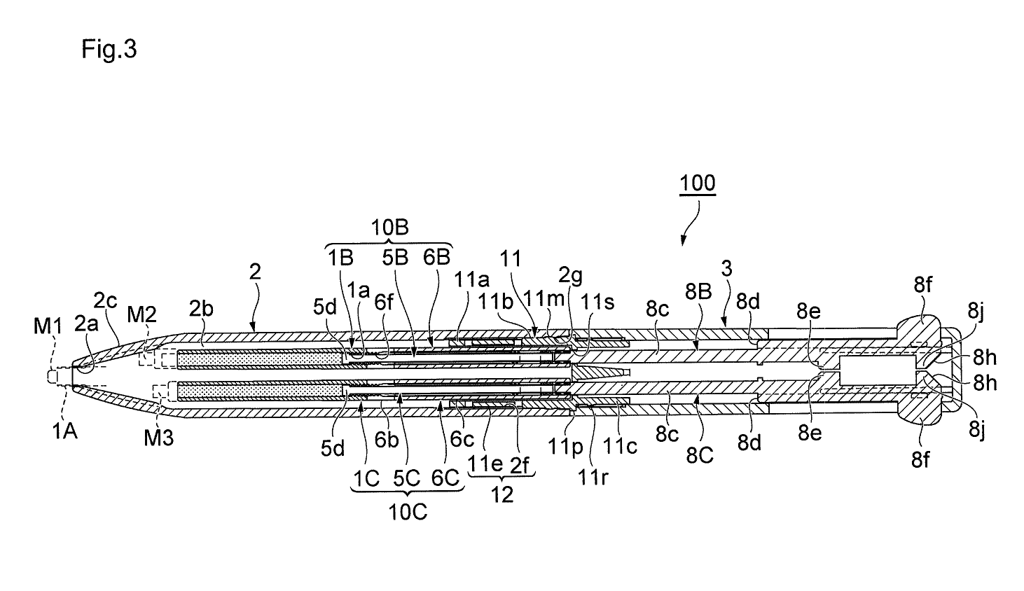

FIG. 1 is a side view of a feeding pencil according to the embodiment. FIG. 2 is a side view illustrating the feeding pencil in FIG. 1 from which one cartridge is removed. FIG. 3 is a vertical cross-sectional view illustrating the feeding pencil in FIG. 1. As shown in FIG. 1 to FIG. 3, a feeding pencil 100 according to the present embodiment is a variety pencil that appropriately discharges (extrudes) any one of a plurality of drawing materials M1 to M4 filled inside respective four pipe members 1A to 1D by an operation of a user. In this embodiment, the drawing materials M1 to M4 are drawing materials with colors different from one another.

As the drawing materials M1 to M4, for example, the followings can be used: various stick-like cosmetic materials such as a lipstick, a lip gloss, an eyeliner, an eyebrow, a lip-liner, a cheek-color, a concealer, a cosmetic stick, hair color, and a nail art; or a stick-like core of a stationery and a similar material. Further, very soft (such as semisolid-shaped, soft solid-shaped, soft-shaped, jelly-shaped, mousse-shaped, and paste-shaped with these materials contained) stick-like members can be used. A thin-diameter stick-like member whose outer diameter is 1 mm or less, a general stick-like member whose outer diameter is from 1.5 to 3.0 mm, or a thick stick-like member whose outer diameter is 4.0 mm or more can also be used.

The feeding pencil 100 includes a leading tube 2 and a main body 3 as an external configuration. The leading tube 2 internally includes the pipe members 1A to 1D that load the drawing materials M1 to M4. The main body 3 is coupled to a rear end part of the leading tube 2 and engages with the leading tube 2 so as to be relatively rotatable. In the following description, an “axial line” means a center line of the feeding pencil 100 that extends to the front-to-rear of the feeding pencil 100, and an “axial direction” means a direction along the axial line in the front-to-rear direction. It is assumed that the direction in which the drawing materials M1 to M4 are fed out is a forward (a direction of forward movement), and a direction opposite from the forward (a retreat direction) is a rearward.

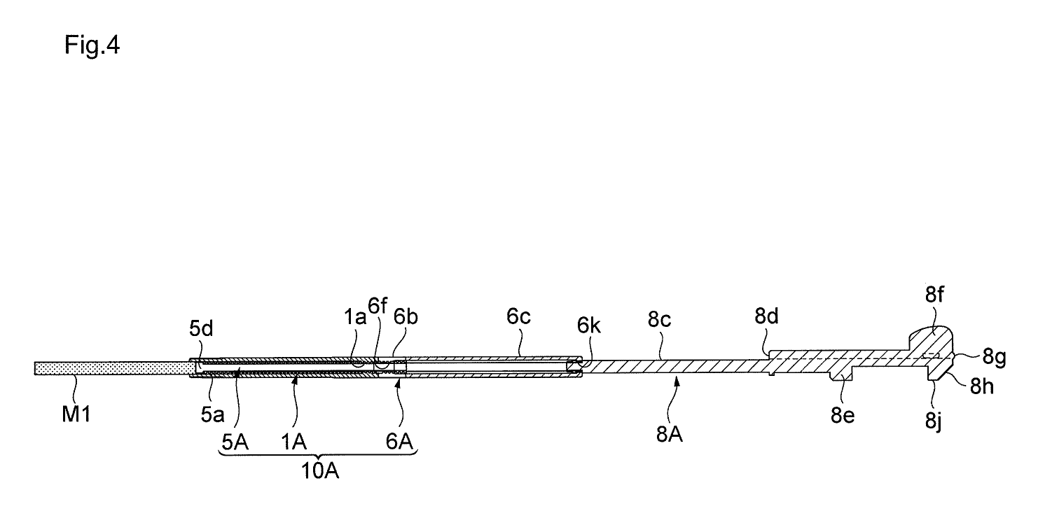

FIG. 4 is a vertical cross-sectional view illustrating a configuration of the pipe member 1A and a peripheral area thereof. As illustrated in FIG. 4, a stick-like movable body 5A having a male screw 5a is screwed with an inside of the pipe member 1A. The movable body 5A is held by a tubular holding member 6A. These pipe member 1A, movable body 5A, and holding member 6A can constitute a cartridge 10A exchangeable for the main body 3. Alternatively, a combination of the pipe member 1A and the movable body 5A can constitute an exchangeable cartridge. The pipe members 1B and 1C have a configuration similar to the pipe member 1A. It is also possible to constitute cartridges 10B and 10C with the pipe members 1B and 1C, movable bodies 5B and 5C, and holding members 6B and 6C, respectively. The same applies to the pipe member 1D.

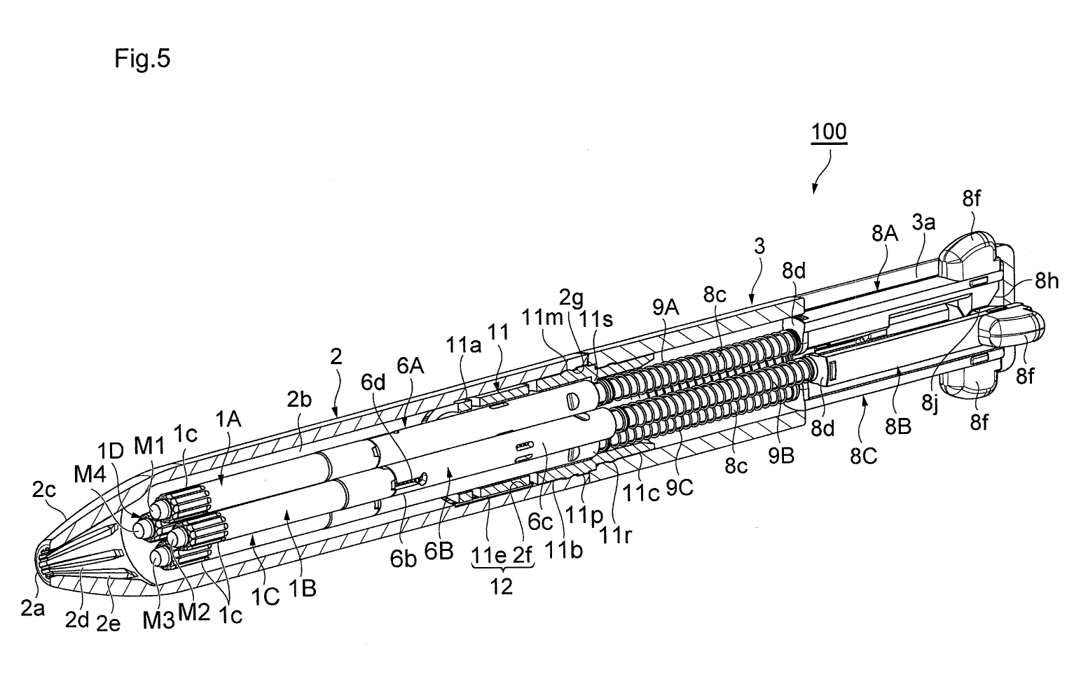

The cartridge 10A includes a sliding part 8A and a spring 9A (see FIG. 5) at the rear part. The sliding part 8A is engaged to the holding member 6A in the axial direction. The spring 9A urges the sliding part 8A rearward. The cartridge 10A is removably attachable to the sliding part 8A in the axial direction. Similarly, the cartridges 10B and 10C include sliding parts 8B and 8C and springs 9B and 9C at the rear parts, respectively. The remaining one cartridge constituting the pipe member 1D similarly includes a sliding part and a spring.

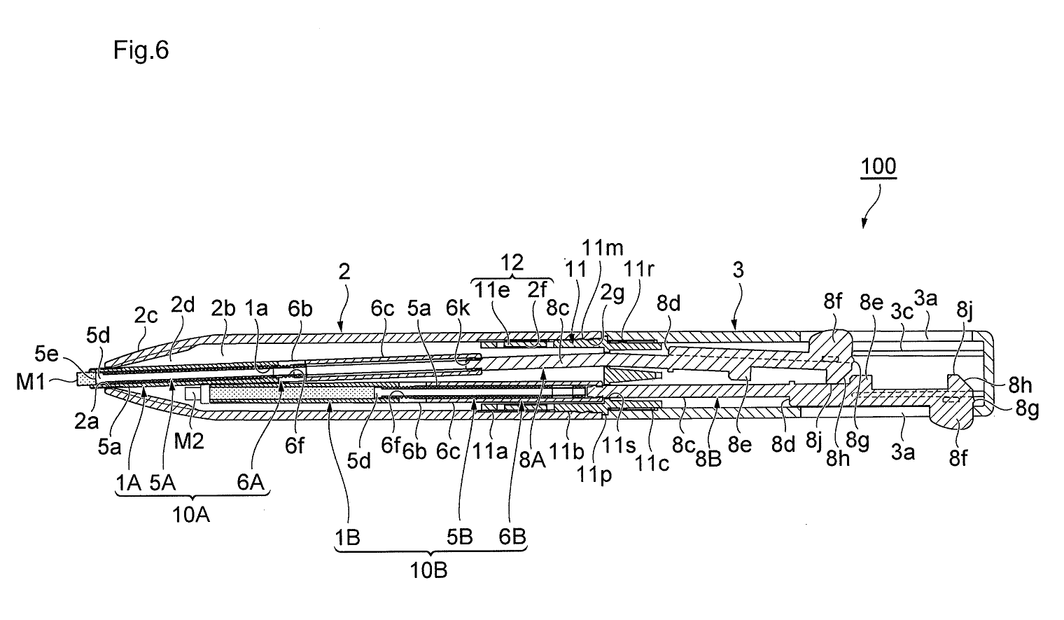

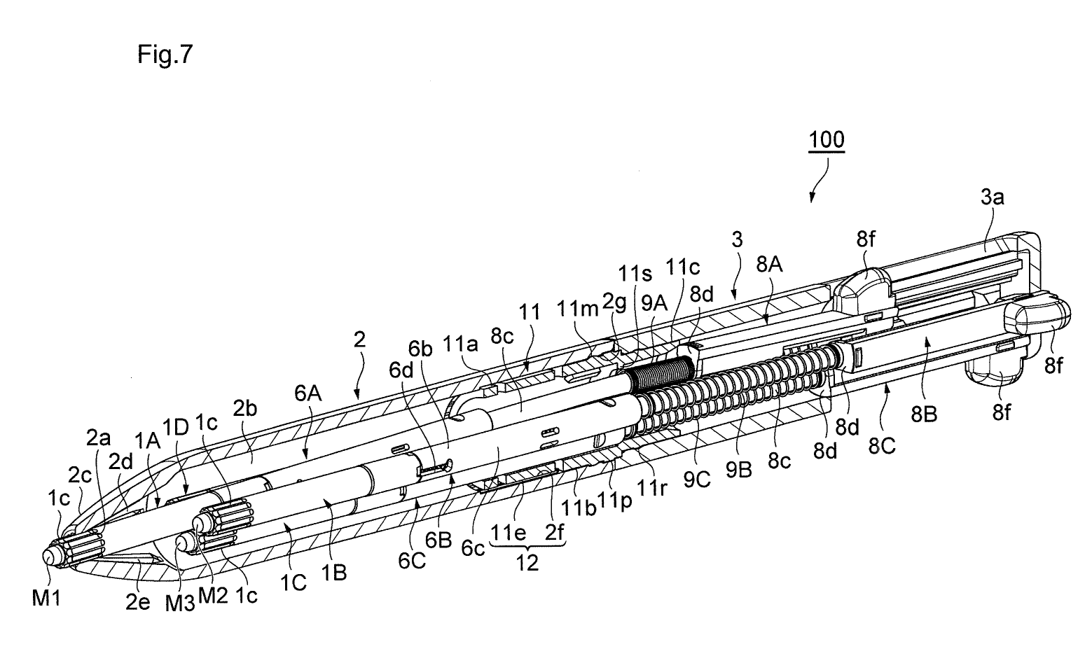

FIG. 5 and FIG. 6 are each cross-sectional perspective view and a vertical cross-sectional view of the feeding pencil 100. FIG. 7 is a cross-sectional perspective view illustrating a forward movement of the one sliding part 8A. As illustrated in FIG. 5 to FIG. 7, the leading tube 2 and the main body 3 internally include the four pipe members 1A to 1D that load the drawing materials M1 to M4, the four movable bodies such as the movable body 5A, the four holding members such as the holding member 6A, the four springs such as the spring 9A, and the four sliding parts such as the sliding part 8A. These four pipe members, four movable bodies, four holding members, four springs, and four sliding parts have an identical configuration except that the drawing materials M1 to M4 different from one another are loaded.

Accordingly, the following designates each of the four pipe members, the four movable bodies, the four holding members, the four springs, and the four sliding parts as a pipe member 1, a movable body 5, a holding member 6, a spring 9, and a sliding part 8. The four cartridges such as the cartridge 10A and the drawing materials M1 to M4 are referred to as a cartridge 10 and a drawing material M, respectively.

A middle tube 11 is engaged to a front end of the main body 3 so as to be synchronously rotatable. The four holding members 6 are held inside the middle tube 11. The middle tube 11 and the leading tube 2 include a ratchet mechanism 12 that allows a relative rotation between the leading tube 2 and the main body 3 (the middle tube 11) only in one direction. This ratchet mechanism 12 regulates the relative rotation between the leading tube 2 and the main body 3 in another direction opposite from the one direction.

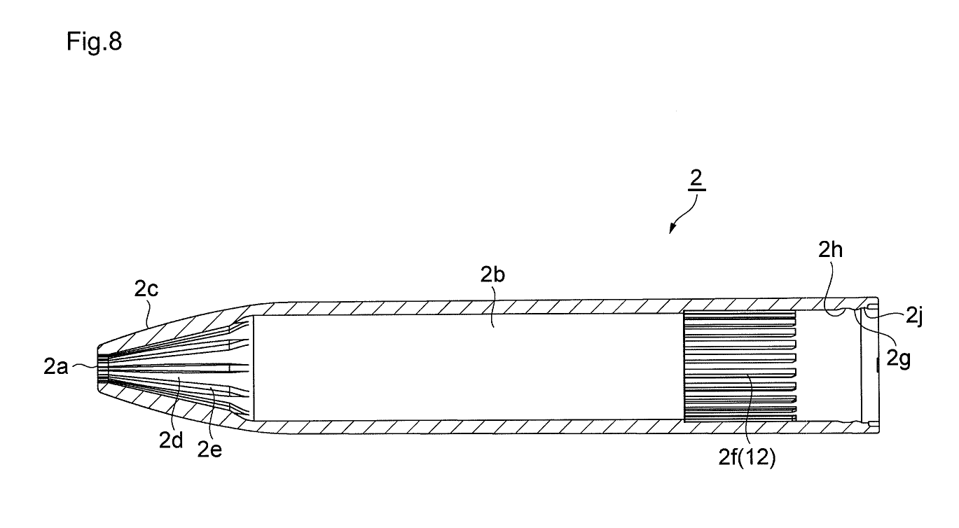

FIG. 8 is a vertical cross-sectional view illustrating the leading tube 2. As illustrated in FIG. 8, the leading tube 2 is made of an ABS resin (a copolymerization synthetic resin of acrylonitrile, butadiene, and styrene). The leading tube 2 has a tubular shape and an opening 2a to cause a front side part of the pipe member 1 to appear on the front end. The leading tube 2 includes therein a housing region 2b to house the four cartridges 10. Any one of the four pipe members 1, which are disposed inside the housing region 2b, is exposed from the opening 2a forward by user's operation.

On a front side of an outer circumferential surface of the leading tube 2, an inclined surface 2c is inclinedly disposed so as to be tapered to the front. An inner circumferential surface 2d on the front side of the leading tube 2 is also tapered to the front side. The inner circumferential surface 2d includes protrusions 2e that circumferentially have a large number of convex parts arranged side by side to engage the pipe members 1 in a rotation direction (a direction around the axial line). These convex parts extend in the inclining direction of the inner circumferential surface 2d. These protrusions 2e extend across the entire region from one end to the other end in this inclining direction. Circumferential intervals of these protrusions 2e shorten as approaching to the front side.

At a rear side portion of the inner circumferential surface of the leading tube 2, a concave-convex part 2f, which is one part constituting the ratchet mechanism 12, is disposed. The concave-convex part 2f circumferentially has 24 pieces of irregularities, which are arranged side by side and extend in the axial direction at a predetermined length. At the rear of the concave-convex part 2f in the inner circumferential surface of the leading tube 2, annular convex parts 2g, annular concave parts 2h, and annular concave parts 2j are disposed. The annular convex parts 2g engage with the middle tube 11 in the axial direction at the rear part of the leading tube 2. The annular concave parts 2h are positioned on the front side of the annular convex parts 2g. The annular concave parts 2j is positioned on the rear side of the annular concave parts 2j.

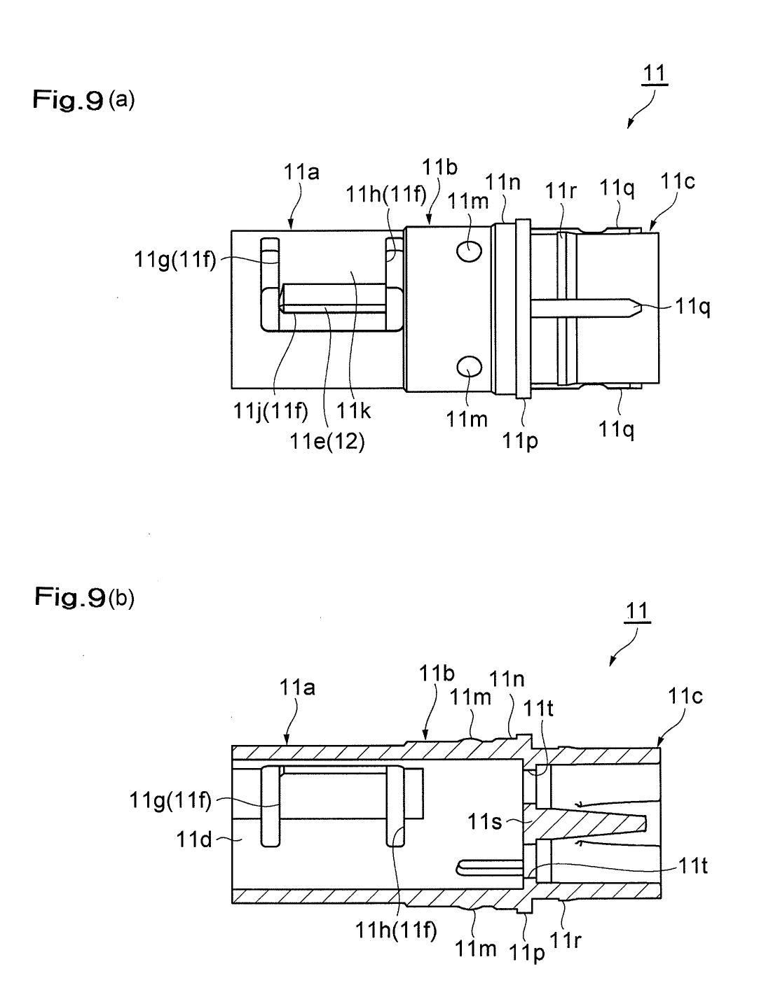

FIG. 9A is a side view illustrating the middle tube 11, and FIG. 9B is a vertical cross-sectional view illustrating the middle tube 11. The middle tube 11 is an injection molded product made of POM (polyacetal) and has an outer shape of stepped cylindrical shape. The middle tube 11 includes a front tube 11a, a center tube 11b, and a rear tube 11c in this order from the forward to the rearward. The center tube 11b has an outer shape with diameter larger than that of the front tube 11a. The rear tube 11c has an outer shape with diameter smaller than those of the front tube 11a and the center tube 11b.

The front tube 11a includes elastic projecting parts 11e, which constitute the other part of the ratchet mechanism 12, at a pair of positions opposed to one another in an inner circumferential surface 11d. These elastic projecting parts 11e engage with the concave-convex part 2f on the leading tube 2 in the rotation direction and are disposed protruding outwardly in a radial direction. At peripheral areas of the elastic projecting parts 11e in the front tube 11a, U-shaped notches 11f to communicate between the inside and the outside of the middle tube 11 are formed. These notches 11f give radial elasticity to the elastic projecting parts 11e. The elastic projecting parts 11e of the middle tube 11 are always brought into abutment with the concave-convex part 2f on the leading tube 2.

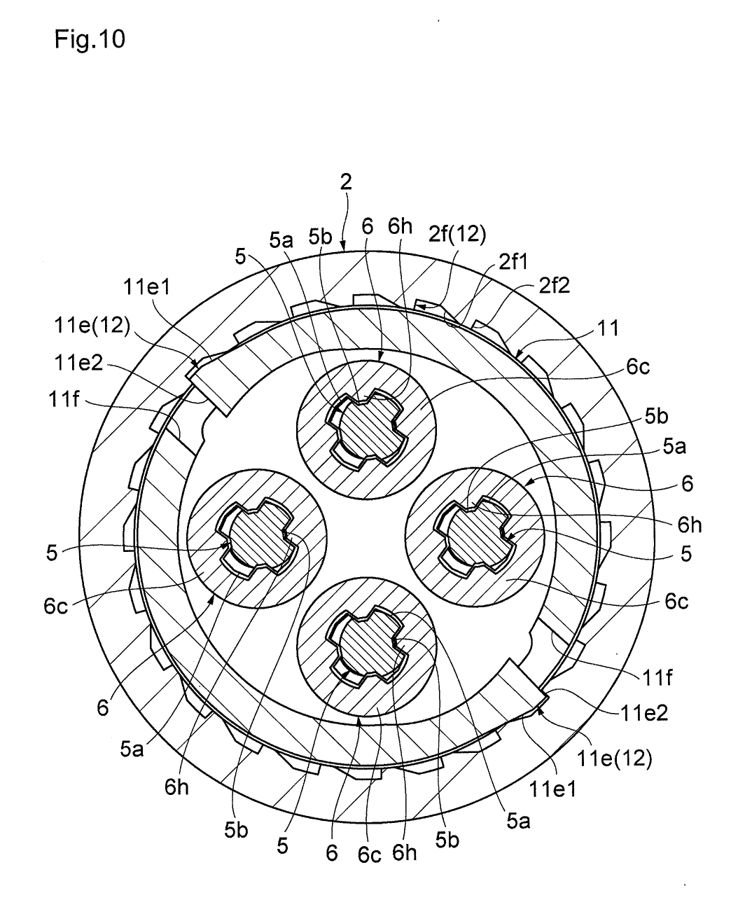

FIG. 10 is a cross-sectional view taken along the line A-A in FIG. 1. As illustrated in FIG. 10, the concave-convex part 2f on the leading tube 2, which is the one part constituting the ratchet mechanism 12, includes inclined surfaces 2f1 and side surfaces 2f2. The inclined surfaces 2f1 incline with respect to the inner circumferential surface of the leading tube 2. The side surfaces 2f2 are formed to be approximately perpendicular to the inner circumferential surface of the leading tube 2. The elastic projecting parts 11e in the middle tube 11, which constitute the other part of the ratchet mechanism 12, includes an inclined surface 11e1 and a side surface 11e2. The inclined surface 11e1 inclines with respect to the outer circumferential surface of the middle tube 11. The side surface 11e2 is formed to be approximately perpendicular to a tangent line of the outer circumferential surface of the middle tube 11.

As illustrated in FIG. 9A and FIG. 9B, the notch 11f in the middle tube 11 includes a pair of slits 11g and 11h and a slit 11j. The slits 11g and 11h are drilled on both sides of the elastic projecting part 11e in the axial direction in the front tube 11a and circumferentially extend. The slit 11j is drilled on one side of the elastic projecting part 11e in the circumferential direction in the front tube 11a. Continuous with the slits 11g and 11h, the slit 11j extends in the axial direction. A wall part surrounded by the notches 11f in the front tube 11a forms an arm 11k having flexibility in the radial direction. Therefore, the elastic projecting part 11e, which is disposed on an outer surface at a tip end of the arm 11k, has an elastic force (an urging force) in the radial direction.

On an outer circumferential surface of the center tube 11b of the middle tube 11, projections 11m, an annular convex part 11n, and a collar part 11p are disposed. The projections 11m are removably engaged to the annular convex parts 2g on the leading tube 2. The annular convex part 11n enters into the annular concave parts 2j on the leading tube 2 from rearward. The collar part 11p is positioned at the rear of the annular convex part 11n. In the middle tube 11, a tube portion positioned on the front side with respect to the collar part 11p is inserted to the leading tube 2 from rearward.

On the rear tube 11c in the middle tube 11, protrusions 11q to engage with the main body 3 in the rotation direction are formed to extend in the axial direction. These protrusions 11q are formed at four uniformly arranged positions in the circumferential direction on an outer circumferential surface of the rear tube 11c. A convex part 11r to engage with the main body 3 in the axial direction is formed at the rear of the collar part 11p. This convex part 11r circumferentially extends between the protrusions 11q.

A holding member housing 11s, which is a site to insert the four holding members 6 through the axial direction, partitions the middle tube 11 at the inner surface side of the collar part 11p. This holding member housing 11s has circular openings 11t to insert the holding members 6 through the axial direction at four uniformly arranged positions in the circumferential direction.

In the middle tube 11, the front tube 11a and the center tube 11b are inserted to the inside of the leading tube 2 from the rear side. Then, the elastic projecting parts 11e in the front tube 11a engage with the concave-convex part 2f on the leading tube 2 in the rotation direction. The projections 11m on the center tube 11b engage with the annular convex parts 2g on the leading tube 2 and are fitted to the annular concave parts 2h. Further, the annular convex part 11n of the center tube 11b enters into the annular concave parts 2j on the leading tube 2.

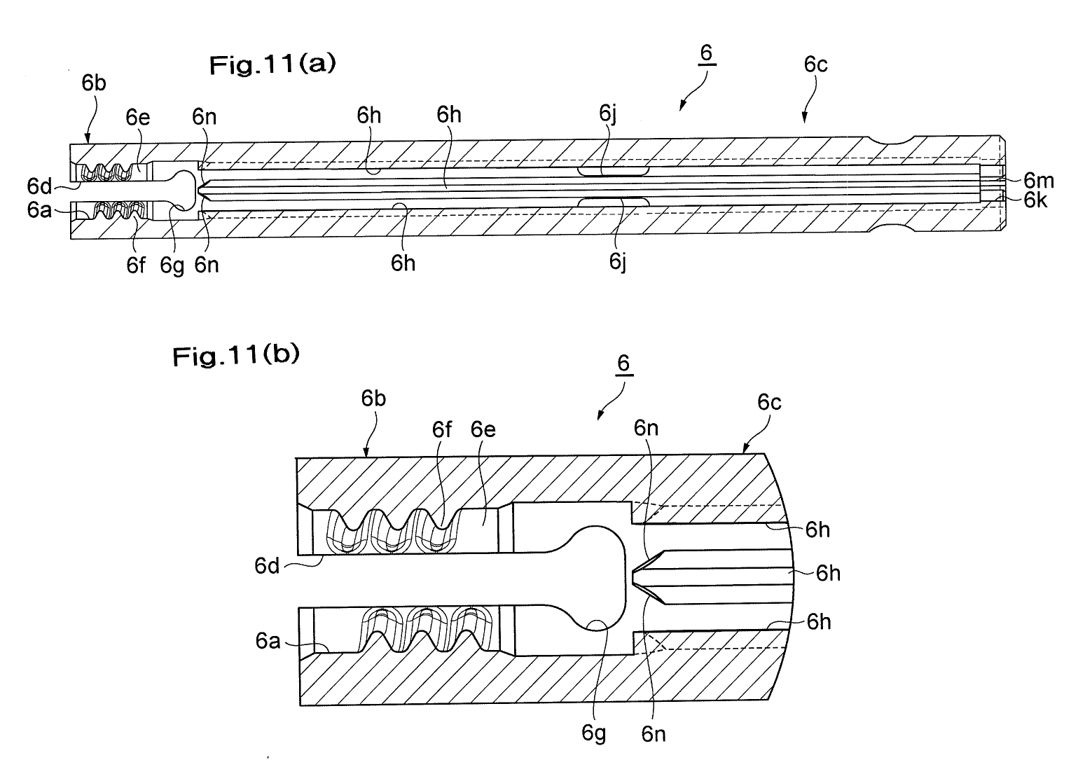

FIG. 11A is a vertical cross-sectional view illustrating the holding member 6, and FIG. 11B is an enlarged view of a front end of the holding member 6 in FIG. 11A. The holding member 6 entirely has a cylindrical shape. As a material of the holding member 6, for example, POM is employed. The holding member 6 includes a hole 6a, a movable body pressing part 6b, and a cylindrically-shaped tubular part 6c. The hole 6a is disposed on the front side of the holding member 6 and houses the movable body 5. The movable body pressing part 6b presses the movable body 5. The tubular part 6c extends rearward from the movable body pressing part 6b.

The movable body pressing part 6b of the holding member 6 includes a pair of slits 6d. The slits 6d extend from the front end to the rear side at a predetermined length so as to be mutually opposed at the inner circumferential surface of the movable body pressing part 6b. With the movable body pressing part 6b including the slits 6d, the elastic force of the resin of the holding member 6 tightens the movable body 5 to inwardly in the radial direction. These slits 6d allow the movable body pressing part 6b to expand the diameter outwardly in the radial direction.

An extension part 6g, which expands viewed from the radial direction, is formed at a rear end of the slits 6d. This extension part 6g appropriately adjusts the elastic force of tightening the movable body 5 from the movable body pressing part 6b. Protrusions 6f in a spiral pattern are formed on an inner surface 6e of the movable body pressing part 6b. The protrusions 6f are disposed at three positions on the inner surface 6e of the holding member 6 along the axial direction. These protrusions 6f are brought into abutment with the male screw 5a of the movable body 5 from outwardly in the radial direction. It is also possible to engage the movable body 5 in the axial direction and removably hold the movable body 5 with the holding member 6.

Four protrusions 6h are disposed at the inside of the tubular part 6c of the holding member 6. The protrusions 6h are disposed at four uniformly arranged positions in the circumferential direction and extend in the axial direction. These protrusions 6h are disposed as a rotation stopper for the movable body 5 with respect to the holding member 6. The protrusions 6h include tapered surfaces 6n tapered to the front end. These tapered surfaces 6n form the protrusions 6h to have a shape with which the movable body 5 is easily inserted from the front side.

These protrusions 6h form an internal space of the tubular part 6c into a non-circular shape (a cruciate shape) in a cross-sectional shape when the tubular part 6c is cut at a plane perpendicular to the axial direction (see FIG. 10). The tubular part 6c further includes through-holes 6j with ellipse shape extending in the axial direction so as to pass through the inside and the outside of the holding member 6. The through-holes 6j support core pins so as to prevent the core pins from being inclined by an injection pressure at the time of molding.

On an inner surface at the rear end of the holding member 6, a protrusion 6m and an annular convex part 6k are formed. The protrusion 6m engages with the sliding part 8 in the rotation direction. The annular convex part 6k engages with the sliding part 8 in the axial direction. The protrusion 6m is disposed on a straight line identical to the above-described protrusions 6h.

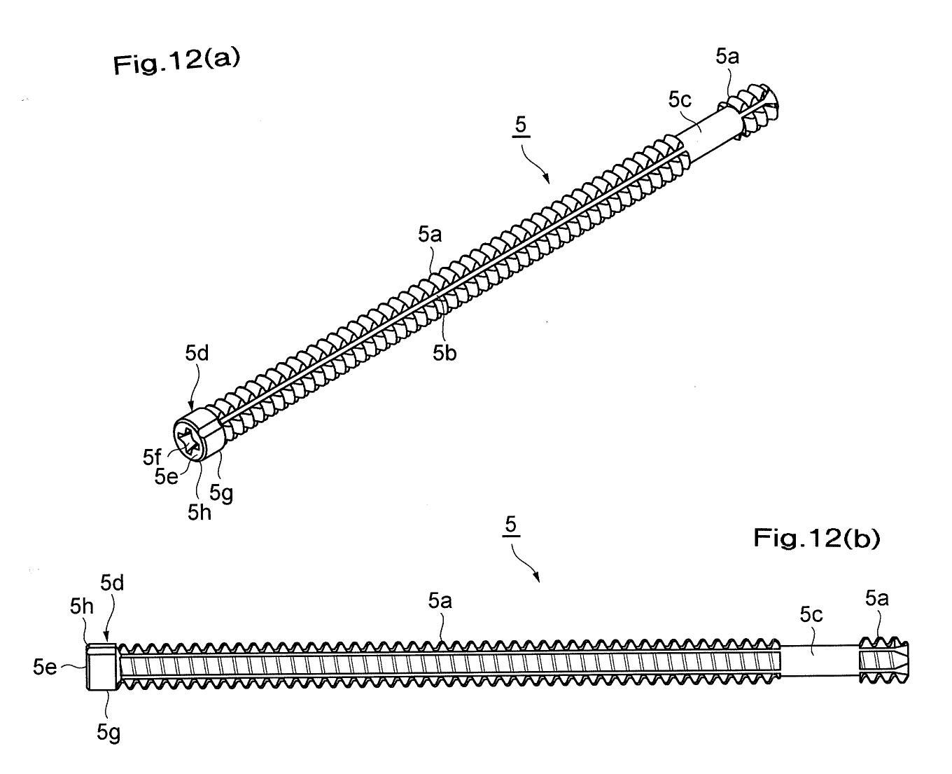

FIG. 12A is a perspective view illustrating the movable body 5, and FIG. 12B is a side view illustrating the movable body 5. The movable body 5 has a stick-like outer shape. As a material of the movable body 5, for example, POM is employed. The movable body 5 includes the male screw 5a and four grooves 5b, which extend in the axial direction, on the outer circumferential surface. The grooves 5b are disposed at four uniformly arranged positions in the circumferential direction.

The movable body 5 has a curved surface part 5c where the male screw 5a is not formed on the surface at the rear side. This curved surface part 5c is disposed to spin around the movable body 5 when the movable body 5 reaches an advance limit. Inserting the male screw 5a, which is positioned at the rear of the curved surface part 5c, to the rear of the protrusions 6f during attachment to the holding member 6 prevents the movable body 5 from dropping from the holding member 6. The movable body 5 wholly forms the male screw 5a in the axial direction. The “wholly forming in the axial direction” includes the case where the male screw 5a is not partially formed such as the case where the curved surface part 5c is formed in the middle of the movable body 5 in the axial direction like this embodiment, in addition to the case where the male screw 5a is formed on all parts of the movable body 5 in the axial direction.

The four grooves 5b on the movable body 5 are disposed to enter the movable body 5 into the protrusions 6h on the holding member 6 (see FIG. 10). These grooves 5b are disposed to rotate the movable body 5 synchronously with the holding member 6. These grooves 5b form the cross-sectional shape when the male screw 5a and the grooves 5b are cut at the plane perpendicular to the axial direction into the non-circular shape (the cruciate shape) corresponding to the internal space of the tubular part 6c of the holding member 6.

A pitch of the male screw 5a in the movable body 5 (a distance between screw threads of the male screw 5a in the axial direction) is, for example, 0.3 mm or more to 1.0 mm or less and preferably 0.6 mm. The conventional pitch of the male screw is typically 2.0 mm or more to 6.0 mm or less. Accordingly, the pitch of the male screw 5a is a fine pitch shorter than the pitch of the general male screws.

The male screw 5a and the grooves 5b in the movable body 5 are inserted from the forward into the holding member 6 so as to provide a clearance between the grooves 5b and the protrusions 6h. Engaging the protrusions 6f, which are disposed on the inner surface 6e of the holding member 6, with the male screw 5a on the movable body 5 holds the movable body 5 by the holding member 6. At this time, the protrusions 6f press the male screw 5a from outwardly in the radial direction, thus increasing a holding force of the movable body 5 by the holding member 6.

A column-shaped extruding part 5d is disposed on the front end of the movable body 5 to extrude the drawing material M inside the pipe member 1 forward. The extruding part 5d includes a bottom surface 5e, which is positioned on the front end, a concave part 5f, which is concaved into a cross shape from the bottom surface 5e, a side surface 5g, which circumferentially extends, and a tapered surface 5h, which inclines with respect to the bottom surface 5e and is continuous with the bottom surface 5e and the side surface 5g. The concave part 5f is a hole to insert a tool to rotate the movable body 5 during the attachment of the movable body 5. Inserting this tool into this concave part 5f allows the movable body 5 to rotate during the attachment and similar work. The bottom surface 5e is a surface to extrude the drawing material M forward.

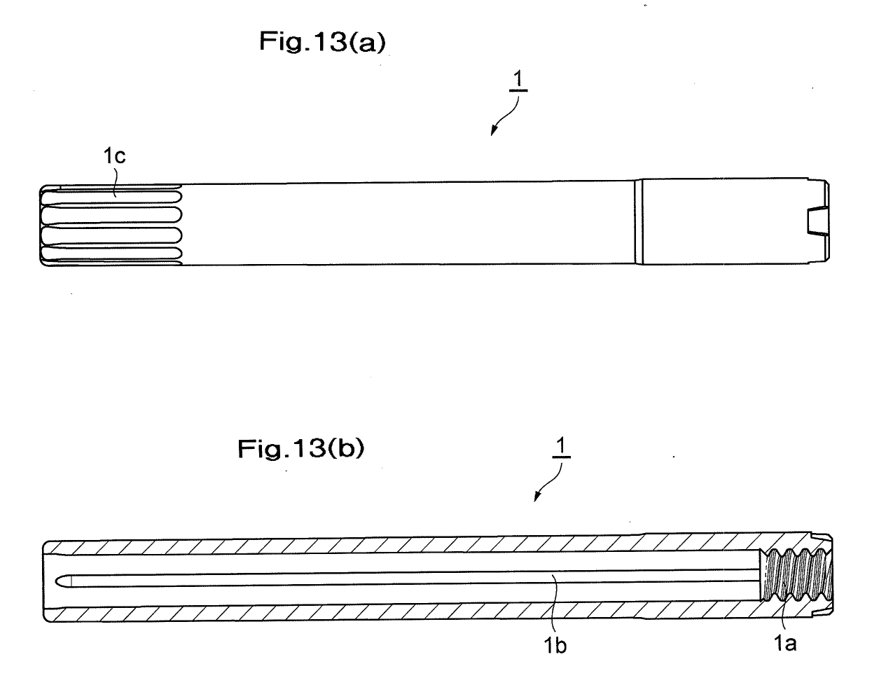

FIG. 13A is a side view illustrating the pipe member 1, and FIG. 13B is a vertical cross-sectional view illustrating the pipe member 1. The pipe member 1 has an approximately cylindrical shape. As a material of the pipe member 1, for example, PP (polypropylene) is employed. Coloring the pipe member 1 with color identical to the drawing material M or configuring the pipe member 1 made of a transparent material ensures easy identification of the color of the drawing material M. A female screw 1a is formed on the rear side of the inner circumferential surface on the pipe member 1 to move the movable body 5 in the axial direction. Similar to the male screw 5a on the movable body 5, a pitch of the female screw 1a on the pipe member 1 (a distance between screw threads of the female screw 1a in the axial direction) is a fine pitch shorter than the pitch of the general female screws.

At the front of the female screw 1a in the inner surface of the pipe member 1, protrusions 1b extending in the axial direction are disposed at four uniformly arranged positions in the circumferential direction. These protrusions 1b ensure preventing the drawing material M loaded to the pipe member 1 from exiting. Although the number of the protrusions 1b is not especially limited, the four protrusions 1b further effectively prevent the drawing material M from exiting. A concave groove 1c is disposed on the front side part on the outer circumferential surface of the pipe member 1 to be engaged to the protrusions 2e of the leading tube 2 in the rotation direction. A plurality of concave parts extending in the axial direction at a predetermined length are circumferentially arranged side by side on the concave groove 1c.

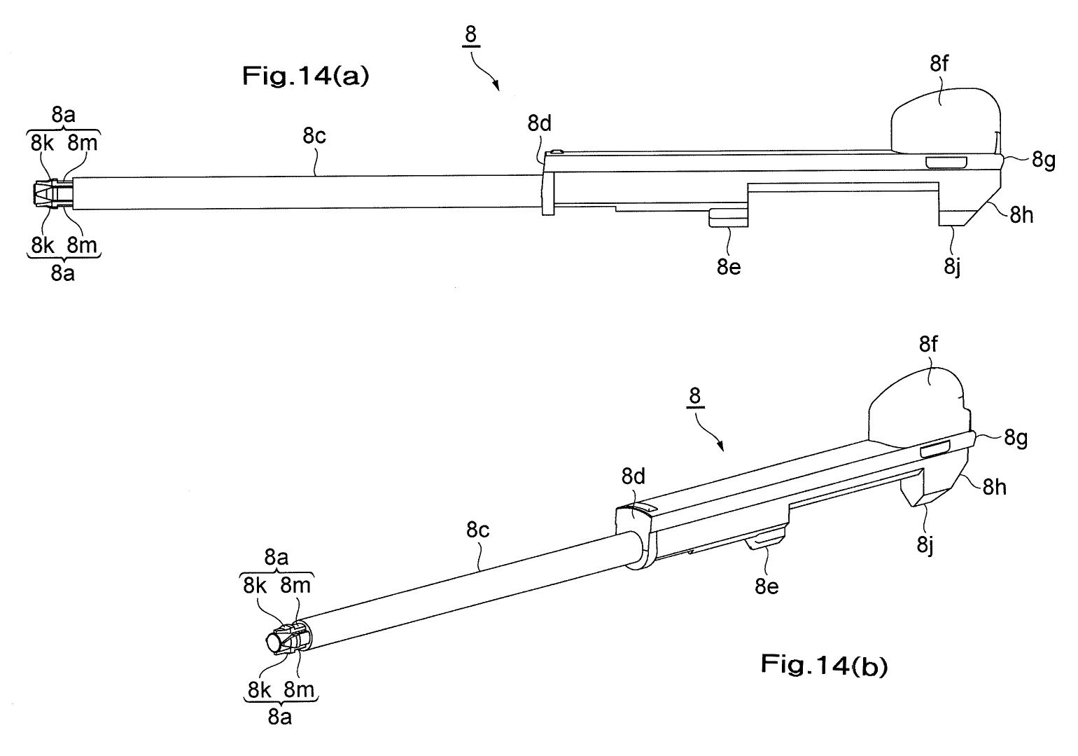

FIG. 14A is a side view illustrating the sliding part 8, and FIG. 14B is a perspective view illustrating the sliding part 8. As a material of the sliding part 8, for example, an ABS resin is employed. A color of the sliding part 8 is, for example, identical to the color of the corresponding drawing material M. Sliding the sliding part 8 with desired color forward by a predetermined amount allows the drawing material M with the desired color to be exposed from the opening 2a on the leading tube 2.

The sliding part 8 has a shape extending in the axial direction. On a front end of the sliding part 8, four claws 8a are disposed to be inserted into the tubular part 6c of the holding member 6 from the rear side. The claws 8a are each disposed at four uniformly arranged positions in the circumferential direction. The claws 8a each have an elastic force in the radial direction and are removably engaged to the annular convex part 6k of the holding member 6. The claw 8a includes an inclined part 8k, which is tapered to the front, and a concave part 8m. The concave part 8m engages the annular convex part 6k in the axial direction at a rear end of the inclined part 8k. Providing the inclined part 8k to this claw 8a forms the sliding part 8 into a shape with which the sliding part 8 is easily inserted into the holding member 6.

The sliding part 8 includes a round-stick-shaped stick-like part 8c around which the spring 9 is wound on the front side. At a rear end of the stick-like part 8c, a flat surface 8d is disposed projecting from the stick-like part 8c to outwardly in the radial direction. The stick-like parts 8c are inserted through openings 11t on the holding member housing 11s of the middle tube 11 in the axial direction. One end of the spring 9 is brought into abutment with the flat surface 8d. Thus, the sliding part 8 includes the stick-like part 8c, which is disposed on the front side, and the flat surface 8d, which projects outwardly in the radial direction at the rear end of the stick-like part 8c, thus having the shape such that the spring 9 is easily attached.

A projecting part 8e is disposed on the rear side of the sliding part 8 to pull and return the other sliding parts 8 rearward. This projecting part 8e projects inwardly in the radial direction in the main body 3 and extends in the axial direction. On the rear end of the sliding part 8, a projecting part 8f, a rear end part 8g, and a projecting part 8j are disposed. The projecting part 8f projects outwardly in the radial direction from the main body 3. The rear end part 8g projects rearward at the rear end of the sliding part 8 and is hooked to the main body 3. The projecting part 8j projects inwardly in the radial direction of the main body 3 and has an inclined surface 8h. The projecting parts 8e of the other sliding parts 8 are brought into abutment with the inclined surface 8h.

The holding member 6 is engaged to the front end of the sliding part 8 configured as described above. At this time, engaging the claws 8a on the sliding part 8 with the annular convex part 6k on the holding member 6 in the axial direction engages the holding member 6 to the front end of the sliding part 8 in the axial direction, thus ensuring removably holding the sliding part 8.

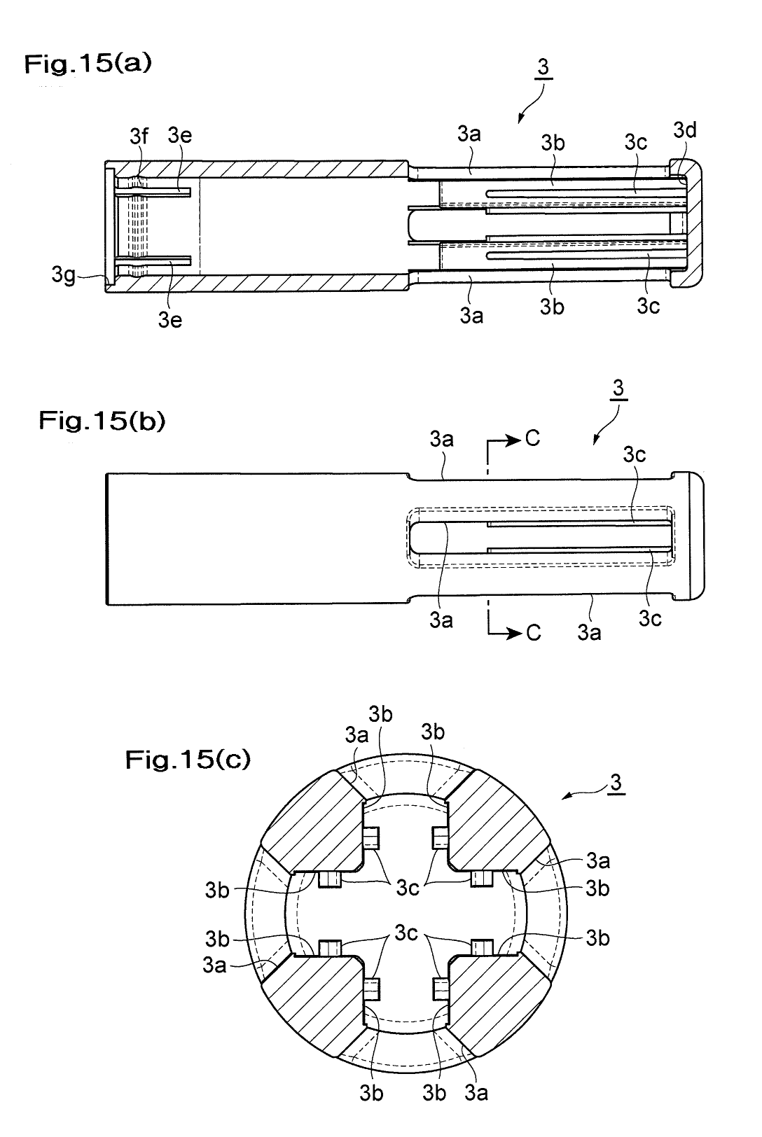

FIG. 15A is a vertical cross-sectional view illustrating the main body 3, FIG. 15B is a side view illustrating the main body 3, and FIG. 15C is a cross-sectional view taken along the line C-C in FIG. 15B. The main body 3 is an injection molded product made of ABS resin and has a closed-bottomed cylindrical shape. Cut-out parts 3a extending in the axial direction to project the projecting part 8f on the sliding part 8 outward are disposed on the rear side of the main body 3. The cut-out parts 3a are disposed at four uniformly arranged positions in the circumferential direction.

Flat parts 3b and projecting parts 3c are disposed at the cut-out parts 3a of the main body 3 inwardly in the radial direction. The flat part 3b extends from the cut-out part 3a inwardly in the radial direction. The projecting part 3c extends in the axial direction at the flat part 3b. The rear side of the projecting part 3c extends up to a bottom surface 3d on the main body 3. As illustrated in FIG. 6, moving the projecting part 8f of the sliding part 8 forward along the cut-out parts 3a on the main body 3 moves the rear end part 8g of the sliding part 8 forward along the projecting parts 3c.

When the rear end part 8g reaches the front end of the projecting parts 3c, this rear end part 8g enters into the cut-out parts 3a inwardly in the radial direction, and the rear end part 8g is hooked to the front ends of the projecting parts 3c. While the rear end part 8g of the one sliding part 8 (for example, the sliding part 8A in FIG. 6) is hooked to the front ends of the projecting parts 3c, the projecting part 8e of the other sliding part 8 (for example, the sliding part 8B in FIG. 6) closely contacts the inclined surface 8h of the one sliding part 8.

As illustrated in FIG. 15A, concave grooves 3e, an annular concave part 3f, and an annular concave part 3g are disposed on a front side of an inner circumferential surface of the main body 3. The concave grooves 3e engage with the protrusions 11q on the middle tube 11 in the rotation direction. The convex part 11r on the middle tube 11 engages with the annular concave part 3f in the axial direction. The collar part 11p on the middle tube 11 enters into the annular concave part 3g from the forward. The concave grooves 3e extend from the annular concave part 3g, which is positioned on the front end of the main body 3, to the rearward at a predetermined length. The concave grooves 3e are disposed at four uniformly arranged positions in the circumferential direction on the inner circumferential surface of the main body 3. The annular concave part 3f circumferentially extends between the concave grooves 3e.

The four sliding parts 8 are inserted into the main body 3 from the front side. The projecting parts 8f on the sliding parts 8 outwardly project from the cut-out parts 3a. The middle tube 11 enters into the front end of the main body 3. When the middle tube 11 enters into the main body 3, the protrusions 11q on the middle tube 11 enter into the concave grooves 3e on the main body 3. The convex part 11r on the middle tube 11 engages with the annular concave part 3f on the main body 3 in the axial direction. Then, the collar part 11p on the middle tube 11 enters into the annular concave part 3g, thus, the middle tube 11 is engaged to the main body 3 to be synchronously rotatable.

As illustrated in FIG. 5 and FIG. 7, the spring 9 (the springs 9A to 9C) is wound around the stick-like part 8c so as to provide the clearance with the outer periphery of the stick-like part 8c of the sliding part 8. One end (the front end) of the spring 9 is brought into abutment with the rear wall on the holding member housing 11s at the middle tube 11. Meanwhile, the other end (the rear end) is brought into abutment with the flat surface 8d, which is positioned near the center of the sliding part 8 in the axial direction.

This spring 9 urges the sliding part 8 rearward.

The following describes operations of the feeding pencil 100 configured as described above for use. The feeding pencil 100 in an initial state illustrated in FIG. 5 positions the four sliding parts 8 at the rear end of the cut-out parts 3a on the main body 3 and positions the four pipe members 1 inside the leading tube 2. As illustrated in FIG. 6 and FIG. 7, with this state, moving the sliding part 8A forward along the cut-out parts 3a by a predetermined amount moves the cartridge 10A, which is engaged to the sliding part 8A in the axial direction, forward, and the drawing material M1 is exposed forward from the opening 2a on the leading tube 2.

At this time, entering the front side part of the pipe member 1A into the inner circumferential surface 2d on the leading tube 2 warps the stick-like part 8c of the sliding part 8A so as to curve with respect to the axial direction, and the concave groove 1c on the pipe member 1A engages with the protrusions 2e on the leading tube 2 in the rotation direction. Then, the rear end part 8g of the sliding part 8A enters inwardly in the radial direction at the front end of the projecting parts 3c on the main body 3.

In this state, for example, when the user relatively rotates the main body 3 in one direction (for example, a clockwise direction) with respect to the leading tube 2, the middle tube 11, the four sliding parts 8, the four holding members 6, and the four movable bodies 5 start rotating in the one direction. The pipe members 1B to 1D where the concave grooves 1c are not engaged to the protrusions 2e on the leading tube 2 rotate in association with the relative rotation in the one direction.

Meanwhile, the holding member 6A coupled to the pipe member 1A where the concave groove 1c is engaged to the protrusions 2e on the leading tube 2 via the movable body 5A starts rotating in the one direction in association with the relative rotation in the one direction. The pipe member 1A where the concave groove 1c is engaged to the protrusions 2e on the leading tube 2 does not rotate together with the rotation of the movable body 5A in the one direction, and the movable body 5A relatively rotates with respect to the pipe member 1A. Accordingly, the relative rotation in the one direction acts a screwing action between the male screw 5a on the movable body 5 and the female screw 1a on the pipe member 1, and the movable body 5A starts moving forward with respect to the pipe member 1A. When the bottom surface 5e on the extruding part 5d of the movable body 5A extrudes the drawing material M1, which is loaded in the pipe member 1A, forward, the movable body 5A and the drawing material M1 start moving forward together with respect to the pipe member 1A.

As illustrated in FIG. 10, at the relative rotation in the one direction, the elastic projecting parts 11e, which constitute the ratchet mechanism 12, on the middle tube 11 engage with the concave-convex part 2f on the leading tube 2 in the rotation direction, and the elastic force by the notches 11f radially urges the elastic projecting parts 11e. This repeats the engagement and disengagement (mesh and disengagement of the mesh) between the elastic projecting parts 11e and the concave-convex part 2f. That is, performing the relative rotation in the one direction with the elastic projecting parts 11e and the concave-convex part 2f engaged in the rotation direction brings inclined surfaces 11e1 of the elastic projecting parts 11e into abutment with the inclined surfaces 2f1 of the concave-convex part 2f. With this state, the inclined surfaces 11e1 slide so as to move up over the inclined surfaces 2f1.

After the elastic projecting parts 11e exceed the convex parts on the concave-convex part 2f, the elastic projecting parts 11e engage with the concave-convex part 2f again in the rotation direction. Consequently, each time that the elastic projecting parts 11e and the concave-convex part 2f engage and disengage with one another, a click feeling is provided to the user. The concave-convex part 2f has 24 irregularities arranged side by side in the circumferential direction; therefore, each time that the relative rotation is performed in the one direction by 15°, the click feeling is provided to the user.

Meanwhile, when the user attempts to relatively rotate the main body 3 in the other direction (for example, counterclockwise), which is a direction opposite from the one direction, with respect to the leading tube 2, the side surfaces 11e2 on the elastic projecting parts 11e, which constitute the ratchet mechanism 12, are brought into abutment with the side surfaces 2f2 on the concave-convex part 2f, thus regulating the relative rotation in the other direction. Accordingly, the leading tube 2 and the main body 3 do not relatively rotate in the other direction. That is, a rotational force (a torque) in the relative rotation in the one direction is set to be a force of ensuring easy rotation while a rotational force in the relative rotation in the other direction is set to a force by which the rotation is not easily performed. For example, with the outer diameter of the main body 3 designed around 14 mm, the torque of the relative rotation in the one direction is set to be 0.1 N·m (newton-meter) or less, and the torque of the relative rotation in the other direction is set to be 0.2 N·m or more.

As illustrated in FIG. 6, in the state where the forward movement of the sliding part 8A moves the pipe member 1A forward and the drawing material M1 is exposed forward, moving the other sliding part 8B forward by the predetermined amount brings the projecting part 8e on the sliding part 8B near the inclined surface 8h of the sliding part 8A into abutment with the inclined surface 8h of the sliding part 8A. The abutment of the projecting part 8e on the sliding part 8B with the inclined surface 8h of the sliding part 8A extrudes the sliding part 8A outwardly in a radial direction, thus disengaging the rear end part 8g of the sliding part 8A with the front end of the projecting parts 3c. The urging force by the spring 9A to the rear presses and returns the sliding part 8A to the rear end position of the cut-out parts 3a.

As described above, this feeding pencil 100 includes the ratchet mechanism 12 that allows the relative rotation between the leading tube 2 and the main body 3 in the one direction and regulates the relative rotation in the other direction. The ratchet mechanism 12 includes the elastic projecting parts 11e, which project from the outer surface on the front tube 11a (the tube portion) of the middle tube 11, and the concave-convex part 2f on the inner surface of the leading tube 2. In this ratchet mechanism 12, the concave-convex part 2f on the inner surface of the leading tube 2 is movable with respect to the elastic projecting parts 11e on the outer surface of the front tube 11a in the axial direction.

The projections 11m disposed on the outer surface of the center tube 11b (the tube portion) in the middle tube 11 removably engage with the annular convex parts 2g, which are disposed on the inner surface of the leading tube 2, in the axial direction. Thus, the middle tube 11 doubles as a function of the ratchet mechanism 12 by the elastic projecting parts 11e and a function to be removably attachable by the projections 11m with the one component. Therefore, the leading tube 2 can be removably attachable to the middle tube 11 in the axial direction, thereby ensuring easy decomposition by removing the leading tube 2 from the middle tube 11. Accordingly, in case of a failure in the component such as the internal cartridge 10, the user can remove the leading tube 2 and easily exchange the internal component.

With the feeding pencil 100, the plurality of drawing materials M are stored in the leading tube 2. The leading tube 2 includes the plurality of sliding parts 8 coupled to the plurality of respective drawing materials M and slidable with respect to the main body 3 by the predetermined amount. Among the plurality of sliding parts 8, the forward movement of the one any given sliding part 8 with respect to the main body 3 by the predetermined amount moves the one any given drawing material M forward. Accordingly, the plurality of drawing materials M can be stored in the one feeding pencil 100 and the one any given drawing material M can be moved forward for use.

That is, the feeding pencil 100 includes the pluralities of pipe members 1, movable bodies 5, and holding members 6. The feeding pencil 100 includes the plurality of sliding parts 8 coupled to the plurality of respective holding members 6 and slidable with respect to the main body 3 by the predetermined amount. Among the plurality of sliding parts 8, the forward movement of the any given sliding part 8 with respect to the main body 3 by the predetermined amount exposes the one any given drawing material M from the leading tube 2. With this state, relatively rotating the leading tube 2 and the main body 3 in the one direction moves the drawing material M forward. This allows the one feeding pencil 100 to internally house the plurality of drawing materials M. Even if the plurality of drawing materials M are housed, this also ensuring maintaining the small-diameter feeding pencil.

The feeding pencil 100 loads the drawing materials M to the inside of the pipe members 1 and houses the movable bodies 5 inside the pipe members 1 and the holding members 6. The movable body 5 wholly forms the male screw 5a in the axial direction. This ensures screwing and holding the male screw 5a at any given position by the pipe member 1 and the holding member 6. The male screw 5a of this movable body 5 is screwed with the female screw 1a on the inner surface of the pipe member 1 and is brought into abutment with the protrusions 6f, which are disposed at the rear of the pipe member 1, on the inner surface 6e of the holding member 6 from the outside.

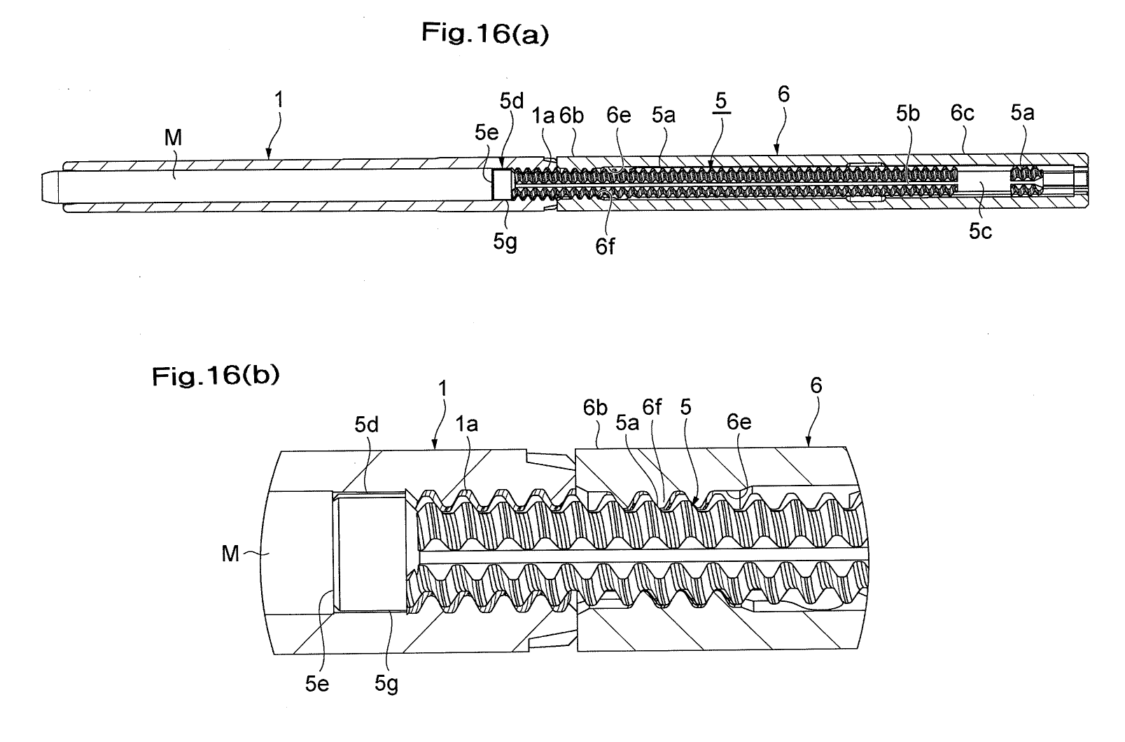

Accordingly, as illustrated in FIG. 16A and FIG. 16B, which are the vertical cross-sectional views of the pipe member 1, the movable body 5, and the holding member 6, the pipe member 1 screwed with the movable body 5 and the holding member 6 holding the movable body 5 can be arranged in the axial direction, thus restraining a radial enlargement of the feeding pencil 100. Therefore, this feeding pencil 100 can achieve the small-diameter feeding pencil 100.

With the feeding pencil 100, for example, the inner diameter of the screw thread of the female screw 1a on the pipe member 1 is slightly larger than the inner diameter of the protrusion 6f on the holding member 6. In view of this, although the fine clearance is formed between the male screw 5a of the movable body 5 and the screw thread of the female screw 1a, a clearance is not formed between the male screw 5a and the protrusions 6f, thereby ensuring always bringing the protrusions 6f into abutment with the male screw 5a.

The protrusions 6f on the holding member 6 are formed in the spiral pattern on the inner surface 6e on the holding member 6. This allows the protrusions 6f to be engaged to the male screw 5a along the shape of the male screw 5a, thereby ensuring increasing the holding force of the male screw 5a by the holding member 6.

The holding member 6 includes the slits 6d extending in the axial direction from the end part on the front side. Providing these slits 6d ensures increasing the radial elastic force at the end part on the front side of the holding member 6. This ensures increasing the radial holding force by the holding member 6, thereby ensuring further reliably restraining the exit of the movable body 5 from the holding member 6.

Although the embodiments of the present disclosure have been described above, the present disclosure is not limited to the embodiments described above, and variations may be made without departing from the gist described in the respective claims or applications to other items may be performed. That is, the configuration of the respective components constituting the feeding pencil 100 can be appropriately changed without departing from the above-described gist

For example, as illustrated in FIG. 8 to FIG. 9B, the above-described embodiment describes the example where the elastic projecting parts 11e in the middle tube 11 and the concave-convex part 2f on the leading tube 2 constitute the ratchet mechanism 12 and the projections 11m, which are disposed on the outer surface of the middle tube 11, and the annular convex parts 2g, which are disposed on the inner surface of the leading tube 2, are removably engaged in the axial direction. However, as a feeding pencil according to a modification, annular convex parts removably engaging with the elastic projecting parts 11e, which constitute the ratchet mechanism 12, in the axial direction may be disposed on the inner surface of the leading tube 2.

That is, the feeding pencil according to this modification includes the tubular main body 3, the leading tube 2, and the middle tube 11. The leading tube 2 is engaged with the main body 3 to be relatively rotatable. The middle tube 11 has the tube portions (the front tube 11a and the center tube 11b) inserted into the inside of the rear side of the leading tube 2. The middle tube 11 is positioned between the leading tube 2 and the main body 3. The middle tube 11 is engaged to the leading tube 2 to be relatively rotatable. The relative rotation between the leading tube 2 and the main body 3 in the one direction moves the drawing material M forward in the inside of the leading tube 2. The ratchet mechanism 12 allows the relative rotation between the leading tube 2 and the main body 3 in the one direction. The ratchet mechanism 12 regulates the relative rotation in the other direction opposite from the one direction. The ratchet mechanism 12 includes the elastic projecting parts 11e and the concave-convex part 2f. The elastic projecting parts 11e project from the outer surface on the tube portion of the middle tube 11 and have the elasticity in the radial direction. The concave-convex part 2f is disposed on the inner surface of the leading tube 2. The concave-convex part 2f engages with the elastic projecting parts 11e to be movable in the axial direction and rotatable. The elastic projecting parts 11e removably engage with the annular convex part disposed at the inner surface on the leading tube 2 in the axial direction.

As described above, with the feeding pencil according to this modification, the elastic projecting parts 11e removably engage with the annular convex part disposed on the inner surface of the leading tube 2 in the axial direction. Accordingly, the elastic projecting parts 11e, which constitute the ratchet mechanism 12, removably engage with the annular convex parts on the inner surface of the leading tube 2. Thus, the elastic projecting parts 11e also have the function to be removably attachable. Thus, the elastic projecting parts 11e can have the function to be removably attachable. This allows eliminating the projections 11m.

The above-described embodiment describes the example where the annular convex parts 2g, the annular concave parts 2h, which are positioned on the front side of the annular convex parts 2g, and the annular concave parts 2j, which are positioned on the rear side of the annular convex parts 2g, are disposed on the inner surface of the leading tube 2. However, the annular concave parts 2h or the annular concave parts 2j can be omitted. That is, at least any one of the front side of the annular convex parts 2g and the rear side of the annular convex parts 2g can be formed into flat surfaces.

The above-described embodiment describes the example where the projections 11m, which are disposed on the outer surface of the middle tube 11, and the annular convex parts 2g, which are disposed on the inner surface of the leading tube 2, removably engage with one another in the axial direction. However, aspects of the shape and the arrangement of the projections 11m on the middle tube 11 and the annular convex parts 2g on the leading tube 2 are not limited to the above-described example. Further, instead of the projections 11m and the annular convex parts 2g, an annular convex part may be formed on the outer surface of the middle tube 11 and a protrusion may be formed on the inner surface of the leading tube 2. This annular convex part on the outer surface of the middle tube 11 may removably engage with the protrusion on the inner surface of the leading tube 2 in the axial direction. The above-described embodiment describes the example where the middle tube 11 includes the front tube 11a and the center tube 11b, however, appropriately changing the shape of the middle tube is also possible.

As illustrated in FIG. 11A and FIG. 11B, the above-described embodiment describes the example where providing the slits 6d to the holding member 6 increases the radial elastic force at the front end of the holding member 6. This holding member 6 may further include an elastic part that provides an external elastic force to the movable body 5, which is internally held by the holding member 6. Specifically, for example, a circumferentially-extending annular concave part may be formed between the plurality of slits 6d on the outer surface of the holding member 6, and an O-ring, which is an elastic body, may be entered into this annular concave part. In this case, entering the O-ring into the annular concave part tightens the movable body 5 held by the holding member 6 inwardly in the radial direction, thus further reliably preventing the movable body 5 from exiting from the holding member 6. That is, the elastic force outwardly in the radial direction by the elastic part ensures further increasing the holding force by the holding member 6.

The above-described embodiment describes the example where the protrusions 6f on the holding member 6 are formed in the spiral pattern on the inner surface 6e of the holding member 6. However, the aspects of the shape and the arrangement of the protrusions formed on the inner surface 6e of the holding member 6 are not limited to the above-described example. For example, protrusions in a pattern other than the spiral pattern may be disposed at a plurality of positions along the axial direction on the inner surface 6e of the holding member 6. In this case as well, the plurality of protrusions disposed along the axial direction each press the male screw 5a of the movable body 5 outwardly in the radial direction. This ensures causing the male screw 5a to be less likely to exit from the holding member 6. Thus, the plurality of protrusions disposed along the axial direction can increase strength against the exit of the male screw 5a.

Further, the above-described embodiment describes the example where the protrusions 6f on the holding member 6 are disposed at the three positions along the axial direction on the inner surface 6e of the holding member 6. However, the protrusion(s) 6f may be disposed at one position, two positions, or four positions or more along the axial direction.

As illustrated in FIG. 13B, the above-described embodiment describes the example where the protrusions 1b are disposed at four uniformly arranged positions in the circumferential direction on the front of the female screw 1a in the inner surface of the pipe member 1. These protrusions 1b prevent the drawing material M loaded to the pipe member 1 from exiting. However, measures to prevent the drawing material M from exiting may be taken with members other than the protrusions 1b. For example, instead of the protrusions 1b, measures to increase a friction coefficient may be taken on the inner surface of the pipe member 1. Alternatively, the measures to prevent the exit may be taken by forming the inner surface of the pipe member 1 into a non-circular shape such as a polygonal shape.

The above-described embodiment describes the feeding pencil 100, a variety pencil, which includes the drawing materials M1 to M4 with colors different from one another. However, the feeding pencil may include drawing materials with thicknesses different from one another. Additionally, the feeding pencil may include a plurality of drawing materials whose materials or applications are different from one another. The number of the drawing materials is not limited to four but may be two, three, or five or more.

Further, the feeding pencil according to the present disclosure may not be a variety pencil. That is, the feeding pencil according to the present disclosure may include each one of the drawing material, the pipe member, the movable body, and the holding member.

What is claimed is:

1. A feeding pencil comprising:
a tubular main body;
a leading tube configured to be rotatably engaged with the main body;
a middle tube having a tube portion configured to be inserted into a rear side portion of the leading tube, the middle tube being positioned between the leading tube and the main body, the middle tube being configured to be rotatably engaged with the leading tube, the relative rotation between the leading tube and the main body in one direction moving a drawing material forward inside of the leading tube; and
a ratchet mechanism configured to allow the relative rotation between the leading tube and the main body in one direction, the ratchet mechanism being configured to regulate the relative rotation in other direction opposite from the one direction, wherein:
the ratchet mechanism includes an elastic projecting part and a concave-convex part, the elastic projecting part projecting from an outer surface on the tube portion, the elastic projecting part having elasticity in a radial direction, the concave-convex part being disposed on an inner surface of the leading tube, the concave-convex part being configured to engage with the elastic projecting part to be movable in an axial direction and rotatable, and
a projection disposed at any one of the outer surface of the tube portion and the inner surface of the leading tube is configured to removably engage with an annular convex part disposed at another in the axial direction.

2. The feeding pencil according to claim 1, wherein:
the plurality of drawing materials are stored in the leading tube,
a plurality of sliding parts coupled to the plurality of drawing materials respectively are disposed, the plurality of sliding parts being slidable with respect to the main body by a predetermined amount, and
one arbitrary sliding part, out of the plurality of sliding parts, moves forward by a predetermined amount with respect to the main body, whereby the drawing material coupled with the one arbitrary sliding part is exposed from the leading tube, and in this state, the leading tube and the main body are relatively rotated in one direction, which allows the drawing material to move forward.
